(19) United States
(12) Patent Application Publication
(10) Pub. No.: US 2006/0164568 A1
(43) Pub. Date: Jul. 27, 2006

(54) Light control plate and liquid crystal display having the same

(76) Inventors: Jung-Wook Paek, Suwon-si (KR); Jin-Soo Kim, Seoul (KR); Byung-Yun Joo, Goyang-Si (KR); Ju-Hwa Ha, Seoul (KR); Jin-Sung Choi, Cheonan-Si (KR)

Correspondence Address: CANTOR COLBURN, LLP, 55 GRIFFIN ROAD SOUTH, BLOOMFIELD, CT, 06002, US

(21) Appl. No.: 11/338,331

(22) Filed: Jan. 24, 2006

(30) Foreign Application Priority Data
Jan. 27, 2005 (KR) 2005-0007486

(51) Int. Cl. G02F 1/1335

(52) U.S. Cl. 349/64

(57) ABSTRACT

A light control plate includes a base part and a lenticular shaped first light dispersion part combined with at least one side of the base part to disperse light provided from an exterior of the light control part. Accordingly, a light control plate and a thin liquid crystal display including the light control plate is provided to assure uniform brightness.

This application claims priority to Korean Patent Application No. 2005-0007486, filed on Jan. 27, 2005 and all the benefits accruing therefrom under 35 U.S.C. §119, and the contents of which in its entirety are herein incorporated by reference.

### BACKGROUND OF THE INVENTION

1. Field of the Invention

The present invention relates, in general, to a light control plate and a liquid crystal display having the same and, more particularly, to a light control plate and a thin liquid crystal display which has the light control plate so as to realize uniform brightness.

2. Description of the Related Art

A liquid crystal display (“LCD”) includes a liquid crystal panel having a thin film transistor (“TFT”) substrate and a color filter substrate, and liquid crystals injected between both substrates. Since the LCD is a non-emitting device, it includes a backlight unit for providing light to a rear part of the TFT substrate. A transmissivity is controlled depending on an arrangement of the liquid crystals. The liquid crystal panel and the backlight unit are contained in a chassis.

Generally, the backlight unit includes a light source part for providing light onto the liquid crystal panel, and an optical member for reflecting or concentrating light provided from the light source part to enable light to be incident on the liquid crystal panel. The optical member mainly includes a diffusion plate, a diffusion sheet, a prism sheet, and a protective sheet.

The backlight unit may either be an edge-type or a direct-type depending on a position of the light source part.

The direct-type backlight unit has a structure that is suitable to enable the LCD to have a large size, and includes one or more light sources provided on a lower side of the liquid crystal panel, thereby providing light onto the entire liquid crystal panel. The direct-type backlight unit is advantageous in that, since a plurality of light sources can be used in comparison with the edge-type backlight unit, it is possible to assure high brightness.

However, the conventional LCD is problematic in that there is a difference in brightness between a plurality of channel parts onto which light is provided from the light source and non-channel parts which are formed between the channel parts, thus dark lines are formed on the liquid crystal panel. In other words, since brightness is non-uniform, a display quality is degraded.

Furthermore, since the optical member includes a plurality of layers, it becomes undesirably difficult to realize a thin liquid crystal display.

### BRIEF SUMMARY OF THE INVENTION

Accordingly, in an exemplary embodiment of the present invention, a light control plate and a thin liquid crystal display that includes the light control plate and assures uniform brightness is provided.

The foregoing and/or other aspects of the present invention are achieved by providing a light control plate including a base part and a first light dispersion part having a lenticular shape and combined with at least one side of the base part to disperse light provided from an exterior of the light control plate.

According to an exemplary embodiment of the present invention, the first light dispersion part has a radius of approximately 50 μm.

According to an exemplary embodiment of the present invention, the light control plate includes a plurality of first light dispersion parts, and a pitch between adjacent first light dispersion parts is approximately 100 μm.

According to an exemplary embodiment of the present invention, a plurality of first light dispersion parts are formed on the base part and the plurality of first light dispersion parts come into contact with each other.

According to an exemplary embodiment of the present invention, the plurality of first light dispersion parts is longitudinally extended across a surface of the base part.

According to an exemplary embodiment of the present invention, each first light dispersion part abuts an adjacent first light dispersion part.

According to an exemplary embodiment of the present invention, the base part includes a plurality of bubbles formed therein.

According to an exemplary embodiment of the present invention, the light control plate further includes an adhesive layer interposed between the base part and the first light dispersion part attaching the first light dispersion part to the base part.

According to an exemplary embodiment of the present invention, the adhesive layer includes a plurality of bubbles formed therein.

According to an exemplary embodiment of the present invention, a plurality of first light dispersion parts is randomly arranged on the base part.

According to an exemplary embodiment of the present invention, each first light dispersion part includes a circular-shaped protrusion projecting from the base part.

According to an exemplary embodiment of the present invention, a plurality of circular-shaped first light dispersion parts is evenly arranged on the base part.

According to an exemplary embodiment of the present invention, the plurality of circular-shaped first light dispersion parts is arranged in rows and columns on the base part.

According to an exemplary embodiment of the present invention, the light control plate further includes a second light dispersion part combined with at least one side of the base part and having a shape of a prism, and the first light dispersion part and the second light dispersion part are longitudinally formed in plural on the base part.

According to an exemplary embodiment of the present invention, the first light dispersion parts are formed on both sides of the base part.

According to an exemplary embodiment of the present invention, the first light dispersion part is formed on a first side of the base part, and a second light dispersion part is formed on a second and opposite side of the base part, the second light dispersion part having a different shape than the first light dispersion part.

The foregoing and/or other aspects of the present invention are also achieved by providing a liquid crystal display including a liquid crystal panel on which an image is formed, a light source part for providing light to the liquid crystal panel, and a light control plate provided between the liquid crystal panel and the light source part and comprising a base part and a light dispersion part, is the light dispersion part having a lenticular shape and combined with the base part to disperse light provided from the light source part.

According to an exemplary embodiment of the present invention, the light source part is provided behind the light control plate, and includes any one of a flat light source lamp, a line light source lamp, and a point light source lamp.

According to an exemplary embodiment of the present invention, the light source part is between approximately 5 and approximately 15 mm from the light control plate.

According to an exemplary embodiment of the present invention, a plurality of light dispersion parts are formed on the base part and the plurality of light dispersion parts come into contact with each other.

According to an exemplary embodiment of the present invention, the base part includes a plurality of bubbles formed therein.

According to an exemplary embodiment of the present invention, the liquid crystal display further includes an adhesive layer interposed between the base part and the light dispersion part attaching the light dispersion part to the base part.

According to an exemplary embodiment of the present invention, the adhesive layer includes a plurality of bubbles formed therein.

According to an exemplary embodiment of the present invention, the light control plate includes any one of acryl and polycarbonate.

According to an exemplary embodiment of the present invention, the liquid crystal display further includes a diffusion sheet provided on the light control plate to diffuse light passing through the light control plate.

According to an exemplary embodiment of the present invention, the first light dispersion part has a radius of approximately 50 μm.

According to an exemplary embodiment of the present invention, the light control plate includes a plurality of first light dispersion parts, and a pitch between adjacent first light dispersion parts is approximately 100 μm.

The foregoing and/or other aspects of the present invention are also achieved by providing a backlight assembly including a light source part providing light and a light control plate penetrated by the light, the light control plate including a base part and a lenticular shaped light dispersion part combined with the base part to disperse the light provided by the light source part.

According to an exemplary embodiment of the present invention, a plurality of lenticular shaped light dispersion parts extend longitudinally across a surface of the base part, and each light dispersion part abuts an adjacent light dispersion part.

According to an exemplary embodiment of the present invention, a plurality of prism shaped light dispersion parts are alternatingly arranged with the plurality of lenticular shaped light dispersion parts.

According to an exemplary embodiment of the present invention, a plurality of light dispersion parts are dispersed across a surface of the base part, and each light dispersion part includes a circular-shaped projection.

According to an exemplary embodiment of the present invention, a plurality of light dispersion parts are arranged across a first surface of the base part facing the light source part and a plurality of light dispersion parts are arranged across a second surface of the base part facing away from the light source part.

### BRIEF DESCRIPTION OF THE DRAWINGS

FIG. 1 is a perspective view of a first embodiment of a light control plate according to the present invention;

FIG. 2 is a sectional view of a second embodiment of a light control plate according to the present invention;

FIG. 3 is a sectional view of a third embodiment of a light control plate according to the present invention;

FIGS. 4 and 5 are perspective views of the fourth and fifth embodiments, respectively, of light control plates according to the present invention;

FIG. 6 is an exploded perspective view of an exemplary embodiment of a liquid crystal display having the first embodiment of the light control plate according to the present invention;

FIG. 7 is a sectional view schematically illustrating an exemplary dispersion of light rays provided from light source parts shown in FIG. 6 by the light control plate; and

FIG. 8 is a sectional view schematically illustrating an exemplary dispersion of light in a liquid crystal display having the second embodiment of the light control plate according to the present invention.

### DETAILED DESCRIPTION OF THE INVENTION

Reference will now be made in detail to exemplary embodiments of the present invention, examples of which are illustrated in the accompanying drawings, wherein like reference numerals refer to like elements throughout. The embodiments are described below in order to explain the present invention by referring to the figures. In the drawings, the thickness of layers, films, and regions are exaggerated for clarity. It will be understood that when an element such as a layer, film, region, or substrate is referred to as being “on” another element, it can be directly on the other element or intervening elements may also be present.

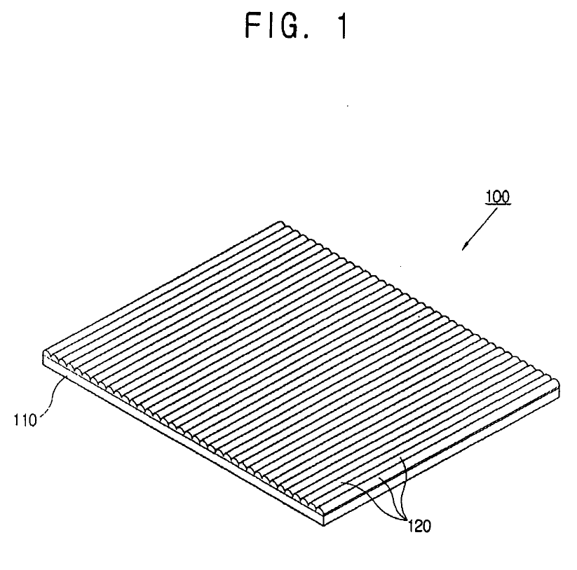

FIG. 1 is a perspective view of a first embodiment of a light control plate according to the present invention. As shown in FIG. 1, a light control plate 100 includes a base part 110 and lenticular shaped first light dispersion parts 120 combined to at least one side of the base part 110 to disperse light provided from an exterior of the light control plate 100.

The base part 110 is typically transparent and made of an acryl-based resin, such as, but not limited to, polymethylmethacrylate (“PMMA”) or polycarbonate (“PC”) having excellent light transmittance.

A plurality of first light dispersion parts 120 is formed on the base part 110 so as to come into contact with each other. That is, where one first light dispersion part 120 ends, another first light dispersion part 120 begins, such that each first light dispersion part 120 is in abutting relationship with any adjacent first light dispersion part 120. In one embodiment, the radius of each light dispersion part 120 is about 50 μm and the pitch there between is about 100 μm. The first light dispersion parts 120 are formed on one side of the base part 110, and function to disperse light provided from the an exterior of the light control plate 100. That is, the first light dispersion parts 120 disperse light to make brightness of light uniform. The lenticular shape of the first light dispersion parts assists in the dispersion of light. It should be understood, with reference to the drawings, that the lenticular shape refers to the shape that is shaped like a lens, and includes an array of optical surfaces, such as a number of lenses closely packed. As illustrated, the optical surfaces include a plurality of convex surfaces. It is preferable to simplify a process of manufacturing the light control plate 100 by integrally injection molding or extruding the first light dispersion parts 120 in conjunction with the base part 110. However, production of the first light dispersion parts 120 is not limited to the above description, and the first light dispersion parts 120 may alternately be formed using an ultraviolet curable resin. That is, after the ultraviolet curable resin is applied on one side of the base part 110, the base part 110 is passed through a roller that is wound by a lenticular pattern. Next, ultraviolet rays are irradiated on a lenticular side to cure the ultraviolet curable resin. While particular methods for forming the light control plate 100 are described, other methods of forming the light control plate 100 would also be within the scope of these embodiments. In the illustrated embodiment, the first light dispersion parts 120 are formed on only one side of the base part 110. Alternatively, the first light dispersion parts 120 may be formed on both sides of the base part 110.

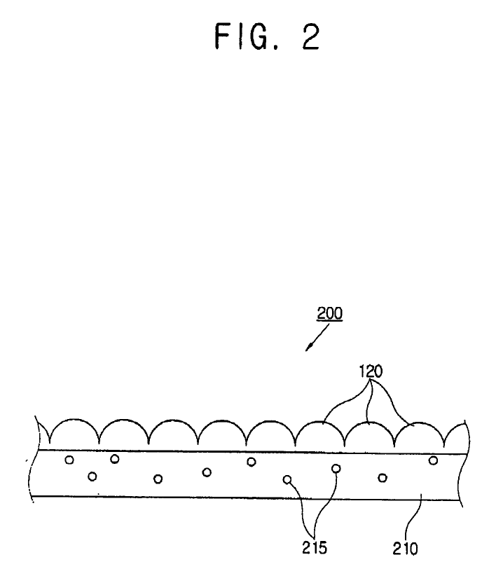

FIG. 2 is a sectional view of a second embodiment of a light control plate according to the present invention. A light control plate 200 is different from that of the first embodiment illustrated in FIG. 1 in that a plurality of bubbles 215 are formed in a base part 210.

The base part 210 may be formed using, by example, an acryl-based resin or PC and a blowing agent mixed together. The blowing agent generates gas at a predetermined temperature or higher to form the bubbles 215. Accordingly, light provided from an exterior of the light control plate 200 is scattered by the bubbles 215, and then dispersed by the first light dispersion parts 120. In other words, the bubbles 215 scatter light penetrated into the base part 210. As in the prior embodiment described with respect to FIG. 1, the radius of each light dispersion part 120 is about 50 μm and the pitch there between is about 100 μm.

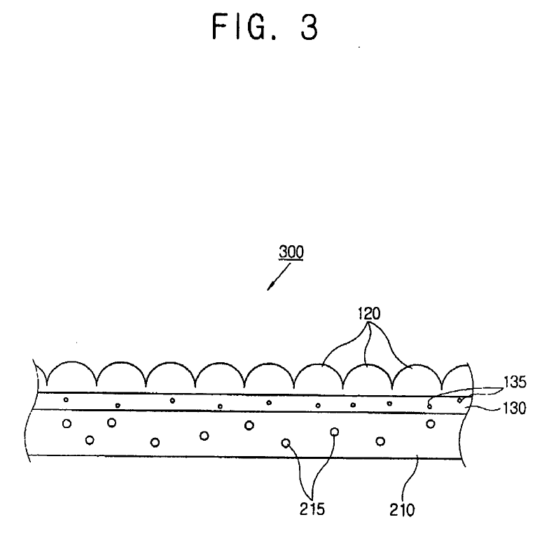

FIG. 3 is a sectional view of a third embodiment of a light control plate according to the present invention. A light control plate 300 is different from that of the first embodiment shown in FIG. 1 in that film-type first light dispersion parts 120 are attached to the base part 210.

It is preferable that the light control plate 300 further includes an adhesive layer 130 for attaching the first light dispersion parts 120 to the base part 210 and is applied between the base part 210 and the first light dispersion parts 120. As in the second embodiment described with respect to FIG. 2, a plurality of bubbles 215 are formed within the base part 210 to scatter light.

The adhesive layer 130 is formed by mixing an adhesive and a blowing agent, and has a plurality of bubbles 135 generated by the blowing agent therein. The adhesive layer 130 unites the base part 210 with the first light dispersion parts 120 and scatters light using the bubbles 135 thereof. As in the prior embodiments described with respect to FIGS. 1 and 2, the radius of each light dispersion part 120 is about 50 μm and the pitch there between is about 100 μm.

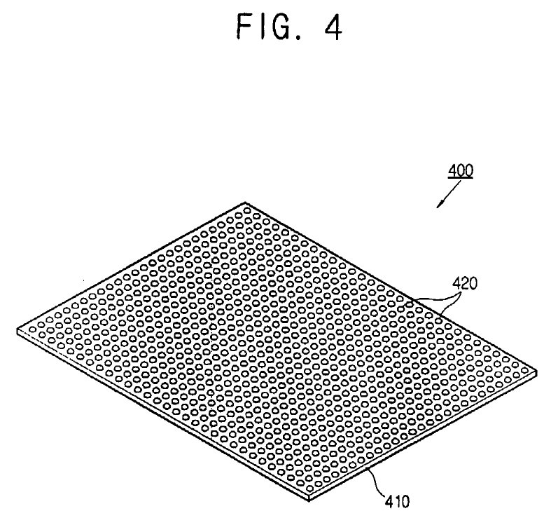

FIG. 4 is a perspective view of a fourth embodiment of a light control plate according to the present invention. A light control plate 400 is different from that of the first embodiment illustrated in FIG. 1 in that first light dispersion parts 420 are dispersed across a base part 410. The first light dispersion parts 420 may be uniformly arranged such as in rows and columns, randomly dispersed across a surface of the base part 410, or alternatively may be variously modified as long as the first light dispersion parts 420 effectively disperse light penetrated into the base part 410 to make brightness uniform.

While the first light dispersion parts 120 are shaped as having a length extending from a first side of the light control plate 100 to an opposite side of the light control plate 100, the first light dispersion parts 410 are instead shaped as bumps, projections, convex protrusions, or the like. Any shape capable of effectively dispersing light penetrating the base part 410 would be within the scope of these embodiments. Although not illustrated in FIG. 4, it should be understood that the arrangement of first light dispersion parts 420 may be used with a base part having bubbles as shown in FIG. 2 and/or with an adhesive layer having bubbles as shown in FIG. 3. Furthermore, the first light dispersion parts 420 may be positioned on only one surface of the light control plate 400, or may be positioned on opposing surfaces of the light control plate 400.

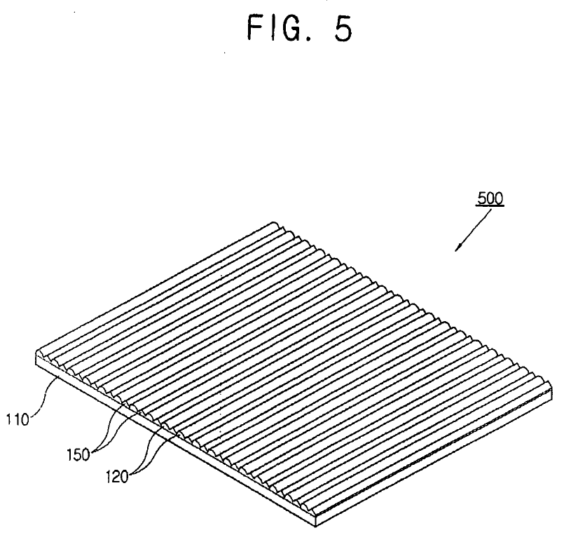

FIG. 5 is a perspective view of a fifth embodiment of a light control plate according to the present invention. A light control plate 500 is different from that of the first embodiment illustrated in FIG. 1 in that it further comprises prism-shaped second light dispersion parts 150.

That is, a plurality of lenticular shaped first light dispersion parts 120 and a plurality of prism-shaped second light dispersion parts 150 are longitudinally formed on a base part 110, such as by extending from a first side to an opposite side of the light control plate 500. The first light dispersion parts 120 and the second light dispersion parts 150 are illustrated as regularly arranged, however the arrangement is not limited to the above description, and may be variously modified as long as it effectively disperses light. By example only, one or more first light dispersion parts 120 may be alternatingly arranged with one or more second light dispersion parts 150.

Although not illustrated in FIG. 5, it should be understood that the arrangement of first and second light dispersion parts 120, 150 may be used with a base part having bubbles as shown in FIG. 2 and/or with an adhesive layer having bubbles as shown in FIG. 3. Furthermore, the first and second light dispersion parts 120, 150 may be positioned on only one surface of the light control plate 500, or may be positioned on opposing surfaces of the light control plate 500.

The light control plate capable of uniformly dispersing light is provided using the above-mentioned constitution, such as described with reference to FIGS. 1-5.

Hereinafter, a detailed description will be given of a liquid crystal display (“LCD”) according to the present invention, referring to the accompanying drawings.

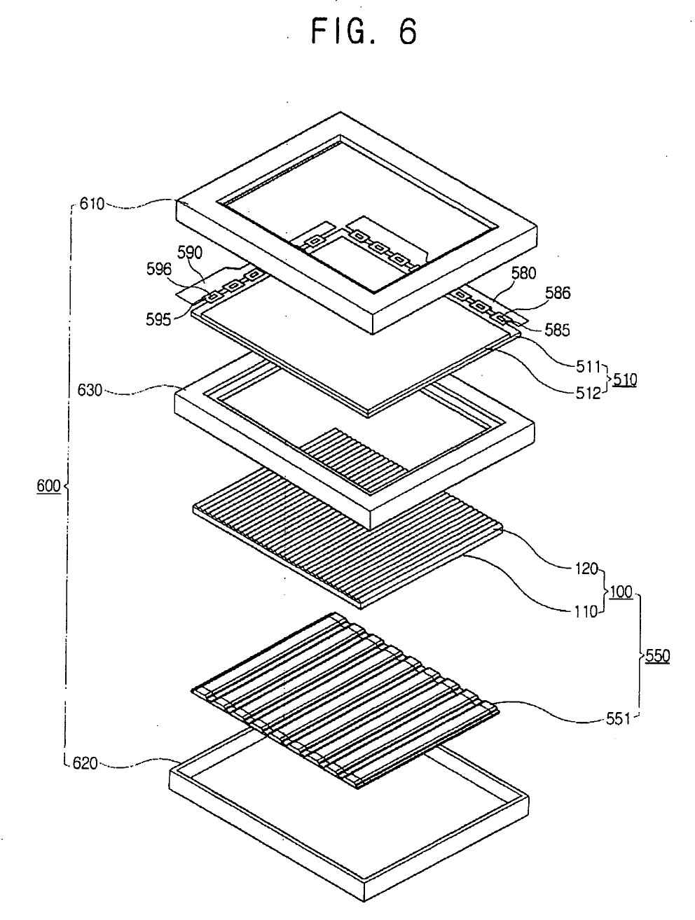

FIG. 6 is an exploded perspective view of an exemplary embodiment of an LCD having the first embodiment of the light control plate according to the present invention. While the light control plate 100 of the first embodiment shown in FIG. 1 is illustrated as employed within the LCD of FIG. 6, the light control plates of the second through fifth embodiments, and variation thereof, may alternately be employed with the illustrated exemplary LCD or within other variations of LCDs. The LCD shown in FIG. 6 includes a liquid crystal panel 510, a backlight unit 550 for providing light onto the liquid crystal panel 510, a source printed circuit board (“PCB”) 580 and a gate PCB 590 for driving the liquid crystal panel 510, and a chassis 600 for receiving the liquid crystal panel 510 and the backlight unit 550 therein.

The liquid crystal panel 510 comprises a thin film transistor (“TFT”) substrate 511 on which a TFT is formed, a color filter substrate 512 which is opposite the TFT substrate 511, and a liquid crystal layer (not shown) interposed between both substrates. The liquid crystal panel 510 forms images depending on an arrangement of liquid crystal molecules within the liquid crystal layer. Since the liquid crystal panel 510 is a non-emitting device, the backlight unit 550 is required.

Driving signals which are supplied from the source PCB 580 and the gate PCB 590 are applied through data flexible circuit films 585 and gate flexible circuit films 595 to the liquid crystal panel 510. Data driving chips 586 and gate driving chips 596 are mounted on the data flexible circuit films 585 and the gate flexible circuit films 595, respectively, to apply the driving signals, which are supplied from the source PCB 580 and the gate PCB 590, to the liquid crystal panel 510.

The chassis 600 includes a lower chassis 620 provided below the backlight unit 550 for receiving the backlight unit 550, a mold frame 630 provided on the backlight unit 550 to support the liquid crystal panel 510 so that the liquid crystal panel 510 is safely mounted thereon, and an upper chassis 610 provided on the liquid crystal panel 510 so as to be combined with the lower chassis 620.

The backlight unit 550 includes light source parts 551 for providing light onto the liquid crystal panel 510, and a light control plate 100 provided on the light source parts 551 to disperse light provided from the light source parts 551 onto the liquid crystal panel 510. The backlight unit 550 may further include a diffusion sheet (not shown) provided on the light control plate 100 to diffuse light penetrated into the light control plate 100.

The light source parts 551 are provided behind the light control plate 100 such that the light source parts 551 are positioned between the lower chassis 620 and the light control plate 100. The light source parts 551 may be any one of a flat light source lamp, such as a flat fluorescent lamp (“FFL”), a line light source lamp, such as a cold cathode fluorescent lamp (“CCFL”), or a point light source lamp, such as an light emission diode (“LED”). In the illustrated embodiment, the FFL is used although it should be understood that other light source parts 551 may be incorporated into the LCD.

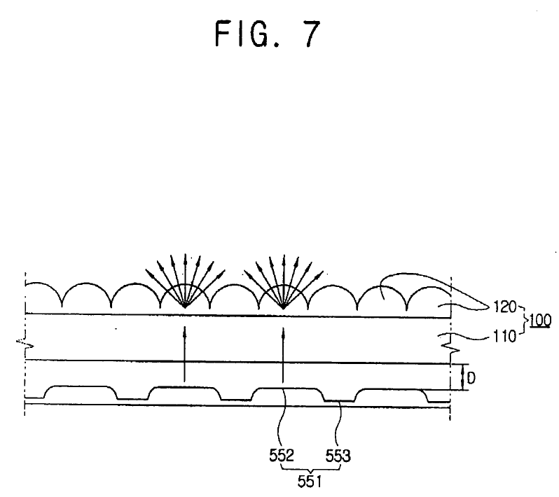

The FFL of the light source parts 551 includes a channel part 552 (FIG. 7) that bulges upward to provide light therefrom, and a non-channel part 553 that is sunken and adjacent to the channel part 552 alternately. Light is provided from the channel part 552 onto the light control plate 100 in a surface light.

Light is provided from the channel part 552 of the FFL of the light source parts 551 onto the liquid crystal panel 510 after being dispersed by the light control plate 100. Accordingly, with respect to light provided onto the liquid crystal panel 510, a difference in brightness of the channel part 552 and the non-channel part 553 is reduced due to the light control plate 100, thus assuring uniform brightness, and thereby improving display quality.

As further shown in FIG. 7, a distance (D) between the FFL of the light source parts 551 and the light control plate 100 is about 5-15 mm, and preferably about 10 mm. Hence, the distance between the FFL of the light source parts 551 and the light control plate 100 is set as narrow as possible, thereby realizing the thin LCD.

As previously described, the light control plate 100 includes a base part 110 and first light dispersion parts 120 on the base part 110. The first light dispersion parts 120 are lenticular shaped and disperse light provided from an exterior of the light control plate 100, such as from the light source parts 551. The light control plate 100 is provided so that the first light dispersion parts 120 face upward herein, such as towards the liquid crystal panel 510. Alternatively, the first light dispersion parts 120 may face downward, such as towards the light source parts 551. In yet another alternative embodiment, the first light dispersion parts 120 may be provided on the base part 110 such that there are first light dispersion parts 120 that face both upwardly and downwardly. Since the light control plate 100 is the same as that of FIG. 1, the same reference numeral is used to denote it, and a detailed description with respect to the light control plate 100 is omitted. Referring to FIG. 7, dispersion of light by the light control plate 100 will be schematically described.

Light from the channel parts 552 of the FFL of the light source parts 551 is provided to the first light dispersion parts 120 through the base part 110 of the light control plate 100. Since the first light dispersion parts 120 are lenticular, it is possible to infinitely disperse the light transmitted there through. Accordingly, boundaries between the channel parts 552 and the non-channel parts 553 become vague and blurred, thus removing dark lines that would otherwise be caused by the non-channel parts 553. Therefore, light from the FFL of the light source parts 551 is provided to the liquid crystal panel 510 after being dispersed by the first light dispersion parts 120, thereby providing the LCD with uniform brightness.

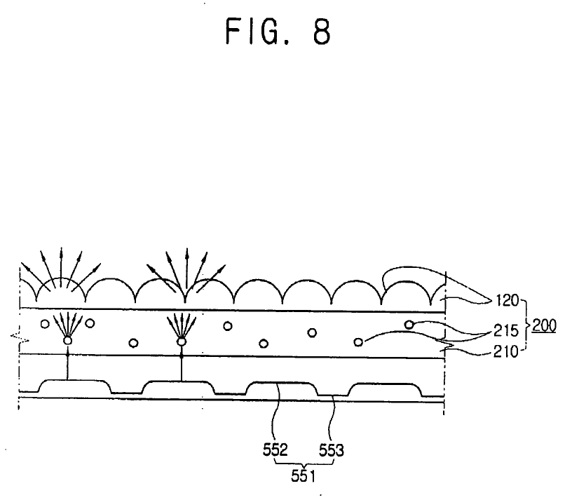

FIG. 8 is a sectional view schematically illustrating an exemplary dispersion of light in the LCD having the second embodiment of the light control plate according to the present invention as shown in FIG. 2. Since the light control plate 200 is the same as that of FIG. 2, a detailed description with respect to the light control plate 200 is omitted.

As shown in FIG. 8, light from the channel parts 552 of the FFL of the light source parts 551 is provided to the first light dispersion parts 120 through the base part 210 of the light control plate 200. The light from the FFL of the light source parts 551 is provided to the first light dispersion parts 120 after being scattered by a plurality of bubbles 215 formed in the base part 210. Since the first light dispersion parts 120 are lenticular, it is possible to infinitely disperse the light transmitted therethrough. Accordingly, boundaries between the channel parts 552 and the non-channel parts 553 become vague and blurred, thus removing dark lines that would otherwise be caused by the non-channel parts 553. Therefore, light from the FFL of the light source parts 551 is provided to the liquid crystal panel 510 after being dispersed by both the bubbles 215 in the base part 210 and the first light dispersion parts 120, thereby providing the LCD with uniform brightness.

In the above-mentioned description, the LCDs having the light control plates according to the first embodiment and the second embodiment are disclosed. Alternatively, an LCD having light control plates according to the third to fifth embodiments, as well as variations thereof, may also be provided.

In the above-mentioned description, the light dispersion parts are formed on an upper side of the base part, that is, facing the liquid crystal panel. Alternatively, the light dispersion parts may be formed on a lower side of the base part, such as by facing the light source parts, or on both sides of the base part facing both the light source parts and the liquid crystal panel. Meanwhile, if the light dispersion parts are formed on both sides of the base part, its shape may be made different. For example, light dispersion parts on an uppers side of the base part may be different from light dispersion parts on a lower side of the base part. Alternatively, the upper and lower side light dispersion parts may have the same shape or may be mirror images of each other.

As described above, the present invention provides a thin LCD capable of assuring uniform brightness.

Although a few embodiments of the present invention have been shown and described, it will be appreciated by those skilled in the art that changes may be made in these embodiments without departing from the principles and spirit of the invention, the scope of which is defined in the appended claims and their equivalents. Moreover, the use of the terms first, second, etc. do not denote any order or importance, but rather the terms first, second, etc. are used to distinguish one element from another. Furthermore, the use of the terms an, an, etc. do not denote a limitation of quantity, but rather denote the presence of at least one of the referenced item.

What is claimed is:

1. A light control plate comprising:
a base part; and
a first light dispersion part having a lenticular shape and combined with at least one side of the base part to disperse light provided from an exterior of the light control plate.

2. The light control plate as set forth in claim 1 wherein the first light dispersion part has a radius of approximately 50 μm.

3. The light control plate as set forth in claim 2, further comprising a plurality of first light dispersion parts, wherein a pitch between adjacent first light dispersion parts is approximately 100 μm.

4. The light control plate as set forth in claim 1, wherein a plurality of first light dispersion parts are formed on the base part and the plurality of first light dispersion parts come into contact with each other.

5. The light control plate as set forth in claim 4, wherein the plurality of first light dispersion parts are longitudinally extended across a surface of the base part.

6. The light control plate as set forth in claim 4, wherein each first light dispersion part abuts an adjacent first light dispersion part.

7. The light control plate as set forth in claim 1, wherein the base part includes a plurality of bubbles formed therein.

8. The light control plate as set forth in claim 7, further comprising an adhesive layer interposed between the base part and the first light dispersion part attaching the first light dispersion part to the base part.

9. The light control plate as set forth in claim 8, wherein the adhesive layer includes a plurality of bubbles formed therein.

10. The light control plate as set forth in claim 1, wherein a plurality of first light dispersion parts is randomly arranged on the base part.

11. The light control plate as set forth in claim 10, wherein each first light dispersion part includes a circular-shaped protrusion projecting from the base part.

12. The light control plate as set forth in claim 1, further comprising a plurality of circular-shaped first light dispersion parts evenly arranged on the base part.

13. The light control plate as set forth in claim 12, wherein the plurality of circular-shaped first light dispersion parts is arranged in rows and columns on the base part.

14. The light control plate as set forth in claim 1, further comprising a second light dispersion part combined with at least one side of the base part and having a shape of a prism, wherein the first light dispersion part and the second light dispersion part are longitudinally formed in plural on the base part.

15. The light control plate as set forth in claim 1, wherein the first light dispersion parts are formed on both sides of the base part.

16. The light control plate as set forth in claim 1, wherein the first light dispersion part is formed on a first side of the base part, and further comprising a second light dispersion part formed on a second and opposite side of the base part, the second light dispersion part having a different shape than the first light dispersion part.

17. A liquid crystal display comprising:
a liquid crystal panel on which an image is formed;
a light source part for providing light to the liquid crystal panel; and
a light control plate provided between the liquid crystal panel and the light source part and comprising a base part and a light dispersion part, the light dispersion part having a lenticular shape and combined with the base part to disperse light provided from the light source part.

18. The liquid crystal display as set forth in claim 17, wherein the light source part is provided behind the light control plate, and comprises any one of a flat light source lamp, a line light source lamp, and a point light source lamp.

19. The liquid crystal display as set forth in claim 18, wherein the light source part is between approximately 5 and approximately 15 mm from the light control plate.

20. The liquid crystal display as set forth in claim 19, wherein a plurality of light dispersion parts are formed on the base part and the plurality of light dispersion parts come into contact with each other.

21. The liquid crystal display as set forth in claim 17, wherein the base part includes a plurality of bubbles formed therein.

22. The liquid crystal display as set forth in claim 21, further comprising an adhesive layer interposed between the base part and the light dispersion part attaching the light dispersion part to the base part.

23. The liquid crystal display as set forth in claim 22, wherein the adhesive layer includes a plurality of bubbles formed therein.

24. The liquid crystal display as set forth in claim 17, wherein the light control plate includes any one of acryl and polycarbonate.

25. The liquid crystal display as set forth in claim 17, further comprising a diffusion sheet provided on the light control plate to diffuse light passing through the light control plate.

26. The liquid crystal display as set forth in claim 17 wherein the light dispersion part has a radius of approximately 50 μm.

27. The liquid crystal display as set forth in claim 26, further comprising a plurality of light dispersion parts, wherein a pitch between adjacent light dispersion parts is approximately 100 μm.

28. A backlight assembly comprising:
a light source part providing light; and,
a light control plate penetrated by the light, the light control plate including a base part and a lenticular shaped light dispersion part combined with the base part to disperse the light provided by the light source part.

29. The backlight assembly as set forth in claim 28, further comprising a plurality of lenticular shaped light dispersion parts extending longitudinally across a surface of the base part, each light dispersion part abutting an adjacent light dispersion part.

30. The backlight assembly as set forth in claim 29, further comprising a plurality of prism shaped light dispersion parts alternatingly arranged with the plurality of lenticular shaped light dispersion parts.

31. The backlight assembly as set forth in claim 28, further comprising a plurality of light dispersion parts dispersed across a surface of the base part, each light dispersion part including a circular-shaped projection.

32. The backlight assembly as set forth in claim 28, further comprising a plurality of light dispersion parts arranged across a first surface of the base part facing the light source part and a plurality of light dispersion parts arranged across a second surface of the base part facing away from the light source part.
